(19) United States
(12) Patent Application Publication
(10) Pub. No.: US 2023/0083068 A1
(43) Pub. Date: Mar. 16, 2023

(54) METHOD AND ARTICLE OF MANUFACTURE OF CUTTER FOR PDC CUTTING SYSTEM

(71) Applicant: DYNATECH SYSTEMS, INC., Elyria, OH (US)

(72) Inventors: Glenn MAHAFFEY, JR., Elyria, OH (US); Ronald NEALEY, Norwalk, OH (US)

(21) Appl. No.: 17/795,184

(22) PCT Filed: Jan. 25, 2021
(86) PCT No.: PCT/US2021/014837

§ 371 Date: Jul. 25, 2022

Related U.S. Application Data
(60) Provisional application No. 62/965,529, filed on Jan. 24, 2020.
(60) Provisional application No. 62/965,591, filed on Jan. 24, 2020.

(51) Int. Cl. E21B 10/16; B24D 99/00; E21B 10/43; E21B 10/50

(52) U.S. Cl. CPC E21B 10/16; B24D 99/005; E21B 10/43; E21B 10/50

(57) ABSTRACT

Material removal systems including milling drum and milling-drumless products, systems, manufactures, and methods for removing material, such as concrete or asphalt, or industrial flowing applications may be augmented with manufactures that provide one or more of an alignment feature for controlling orientation of abrasive elements and manufactures that provide destructive interference and durability of abrasive elements during operation. Manufactures and methods of fabricating manufactures are provided. The method allows configurations of matched pairs of individual abrasive elements to be easily made to a variety of applications in a parametric, semi-parametric, or non-parametric manner, and may provide one or more of an alignment feature for controlling orientation of abrasive elements and sinusoidal, near-sinusoidal or non-sinusoidal destructive interference effects, while providing durability of abrasive elements during operation.

### CROSS-REFERENCE TO RELATED APPLICATIONS

This application claims the benefit of and/or priority to U.S. Provisional Pat. application Serial No. 62/965,591 entitled “CUTTER FOR PDC CUTTING SYSTEM” filed Jan. 24, 2020, and U.S. Provisional Pat. application Serial No. 62/965,529 entitled “ALIGNMENT FEATURE” filed Jan. 24, 2020. The entireties of the above-noted applications are incorporated by reference herein.

### FIELD OF THE INVENTION

The disclosed innovation relates to manufactures and methods of fabricating manufactures for material removal purposes. More particularly, the innovation relates to a product that may be employed in a system that prepares surfaces or removes material (such as, for example concrete, asphalt, resins and the like), from a surface, for example, a surface such as a street may have material removed in relation to removal and/or placement or replacement of street pavement markers, traffic markings, lines, signals, wires such as embedded communication lines, and the like. For another example, a surface such as an industrial floor may have resins or any other type of flooring/flooring material removed. Methods disclosed may allow fabrication and configuration of a manufacture in advantageous manners.

### BACKGROUND

Conventional and recent advances in the art may feature milling drum and drumless milling operations for material removal. In such operations, systems may employ various strike force implements. These implements as may be known in the art may be of permanent or replaceable design, and may by incorporated on picks or plates or affixed directly on drums. It is to be appreciated that replaceable design may be configured as a subassemblies or strike force implements affixed (in a permanent or replaceable manner) to a holder, and such holders attached to a pick or plate. It is to be further appreciated that the prior art includes pre-fabricated rounds and flats of such strike force implements. Such implements may be made from carbide compositions, sintered diamond compositions and the like. In other words, abrasive sections may comprise most any material conventional in the art, such as but not limited to, a polycrystalline diamond (PCD) material. It is to be appreciated that conventional use of these implements have not concerned themselves with orientation of the implement on a pick or plate or drum, and rather may have concerned themselves with the placement of the pick relative to a drum centerline (if at all).

### SUMMARY

The following presents a summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in aspects thereof, comprises articles and methods that may include configurations of abrasive elements for material removal systems. It is to be appreciated that most all systems may feature rotary motion that engages a plurality of abrasive elements to a surface being treated. A zone of contact, known as a working zone may be characterized as the material being removed and the portion of the material removal system in contact with the material being removed. A plurality of abrasive elements may be permanently or removably attached to a material removal system and the plurality of abrasive elements may be attached such that the rotary motion of the system moves the abrasive portion into contact with the material to be worked and provides a working zone that removes material in which the zone is placed. Multiple working zones may be present in different embodiments.

The innovation may provide advantages such that abrasive removal of material in a working zone may be more finely controlled and thereby provide a superior worked surface condition. Control may arise from aspects of the innovation such as for example an orientation control feature, a destructive interference effect feature, or a combination thereof. Aspects of the innovation include methods of manufacture that may create parametric or non-parametric sets with destructive interference effects when used as disclosed, and alternately, or in combination, creating an orientation control feature. It is to be appreciated that the orientation control feature provides advantage to both sinusoidal and other configurations of working edge designs that may assist in providing a superior worked surface condition.

To accomplish the foregoing and related ends, certain illustrative aspects of the innovation are described herein in connection with the following description and the annexed drawings. These aspects are indicative, however, of but a few of the various ways in which the principles of the innovation can be employed, and the subject innovation is intended to include all such aspects and their equivalents. Other advantages and novel features of the innovation will become apparent to those skilled in the art from the following detailed description of the innovation when considered in conjunction with the drawings, and it is intended that the innovation be constructed as including all such modifications and alterations insofar as they come within the scope of the appended claims or the equivalents thereof.

### BRIEF DESCRIPTION OF THE DRAWINGS

The innovation may take physical form in certain parts and arrangement of parts, various embodiments of which will be described in detail and illustrated in the accompanying drawings:

FIG. 1A presents a rotary plane concept according to an aspect of the innovation.

FIG. 1B presents an isometric view of an assembly in an aspect of the innovation.

FIGS. 2A-2H present views of abrasive elements not needing orientation control.

FIGS. 3A-3D present views of an alternative abrasive element not needing orientation control.

FIGS. 4A-4F present views of an abrasive element not using orientation control.

FIGS. 5A-5D present side, front and isometric views of an abrasive element with some similarity to the element of FIGS. 4A-4F according to aspects of the innovation.

FIGS. 6A-6C provide example sinusoidal profiles of a manufacture according to aspects of the innovation.

FIGS. 7A-7D present side, front and isometric views of an abrasive element according to multiple aspects of the innovation.

FIGS. 8A-8D present side, front and isometric views of an abrasive element according to multiple aspects of the innovation.

FIGS. 9A-9D present front and side views of an example pairing of corresponding profiles manufactured from a stock abrasive element according to multiple aspects of the innovation.

FIGS. 10A-10D present side, front and isometric views of an abrasive element according to aspects of the innovation noting features in an alternative embodiment showing selected aspects of the innovation.

### DETAILED DESCRIPTION OF THE PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, structures and devices may be shown in block diagram form in order to facilitate describing the innovation.

While specific characteristics are described herein (e.g., thickness, orientation, configuration, etc.), it is to be understood that the features, functions and benefits of the innovation can employ characteristics that vary from those described herein. These alternatives are to be included within the scope of the innovation and claims appended hereto.

For embodiments as shown in the various figures, a manufacture may be comprised of a predetermined combination of a holder and a plurality of strike force implements. A manufacture also may be a configured strike force implement, and it is to be appreciated that the meaning shall be clear from the context of use. It is also to be appreciated that the innovation may be provided in embodiments for which a strike force implement may be permanently mounted to other elements of a material removal system, as well as embodiments for which mounting may be considered replaceable at one or more different levels. In other words, it is to be appreciated that abrasive element advantageously may be a removable or a non-removable abrasive element (either removable or non-removable from an assembly or removable or non-removable from a removable holder, with the holder and abrasive element considered to be an abrasive implement).

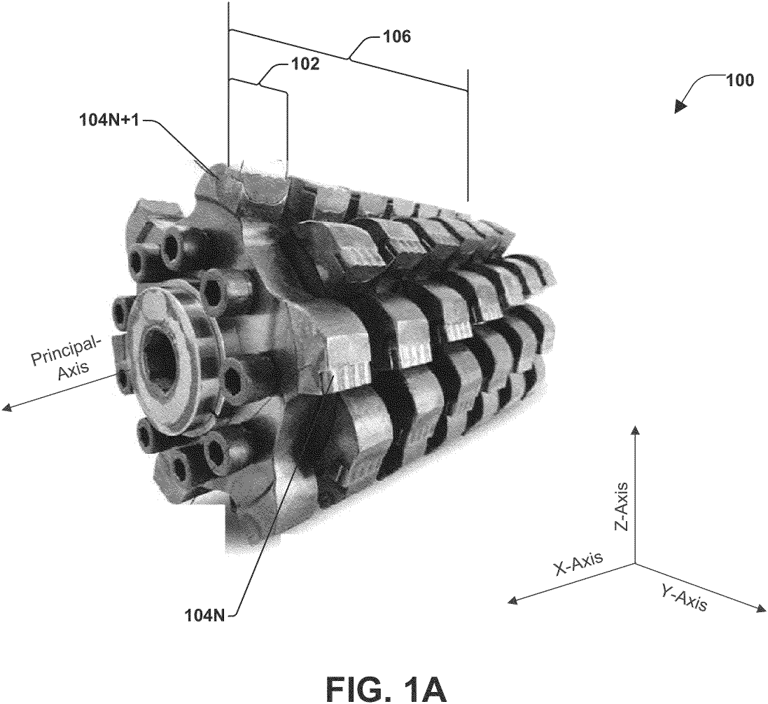

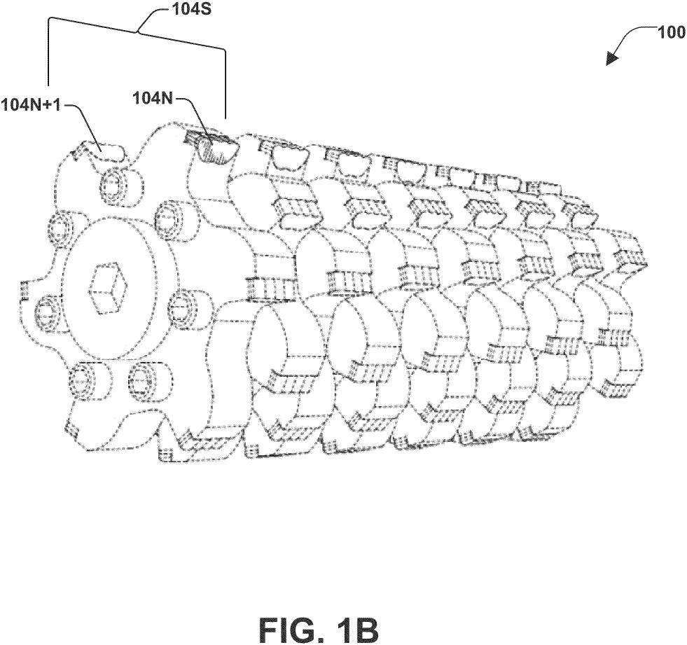

Turning now to FIG. 1A, pictured is an example embodiment that features a presentation of a rotary ‘plane’ or slice or portion of section affected by material removal operations in relation to an aspect of the innovation. Such a plane may be considered to have a specified thickness of an effective working zone, and in an embodiment, provide a plurality of matching profiles of a set of profiles according to aspects of the innovation as will be discussed herein. FIG. 1A presents a drumless milling device comprised of multiple blade segments. It is to be appreciated that a conventional milling drum, outfitted as per the disclosure may also present a rotary plane as herein discussed.

It is to be appreciated that as the power of a material removal system is most always transferred from the material removal device to the material of the surface being treated through a rotation around a principal axis (it is to be appreciated that the principal axis is parallel to an X-Axis as shown), of the material removal system. A slice or section of that system perpendicular to the axis may be considered to be a rotary plane (for example, the plane formed by the two dimensions of the Y-Axis and the Z-Axis). In context, a rotary plane may not be a true plane, as the rotary plane is to be considered to have a thickness 102. Thickness 102 may be considered to be the width of a material removal zone of a particular set of abrasive elements 104S (as shown in FIG. 1B), with each of the set having a plurality of abrasive elements 104N and 104N+1 following the approximately same plane of rotation. It is to be appreciated that the width of working zone created by abrasive element 104N and the width of a working zone created by abrasive element 104N+1 may not be equal, and that the thickness 102 is the cumulative thickness of material worked by the sequential abrasive elements 104N, 104N+1 of a set 104S.

A total working zone 106 may be as shown. In this example, the total working zone may include overlap between adjacent thickness 102 of one rotary plane to a next rotary plane. In other embodiments, a total working zone may be configured to have or not to have such overlap. In yet other embodiments, a total working zone may have a plurality of working zones separated by predetermined spacings. It is to be appreciated that in embodiments, the width of a set 104S may overlap or span one or more adjacent or intermittent sections, providing for a configurable pattern across a total working zone 106. In yet other embodiments, a plurality of working zones may occur at different radial distances from a principal axis of rotation, thereby providing more than one depth of material removed.

It is to be appreciated that while not shown, embodiments may comprise a multitude of chosen material working zone configurations. For example, various radial dimensions may be selected for such applications as providing a controlled work surface including a deeper groove for a laying of a wire, marker, road reflector, or other surface feature. In an embodiment, a center groove of 0.25 inches (or as may be desired), may be provided below an overall worked surface. Another example may be variable surface depth results for reflective inlays in a prepared road surface.

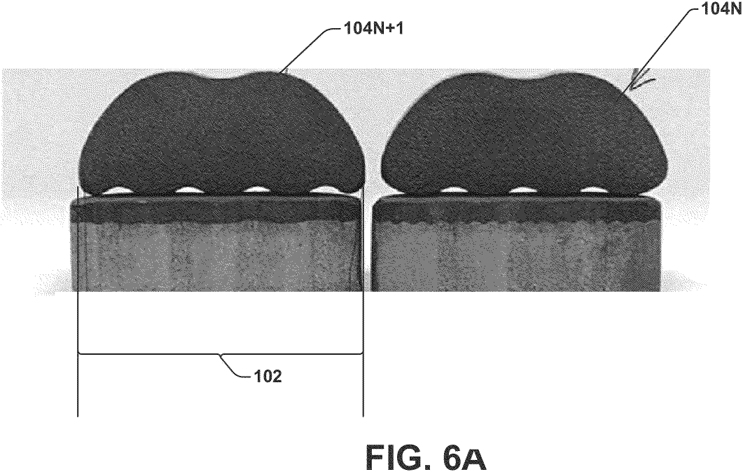

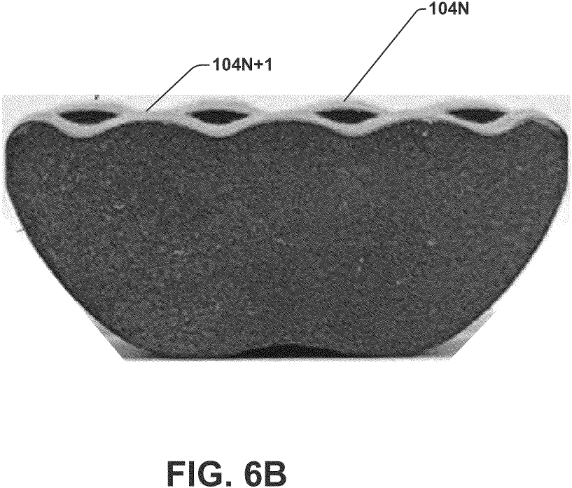

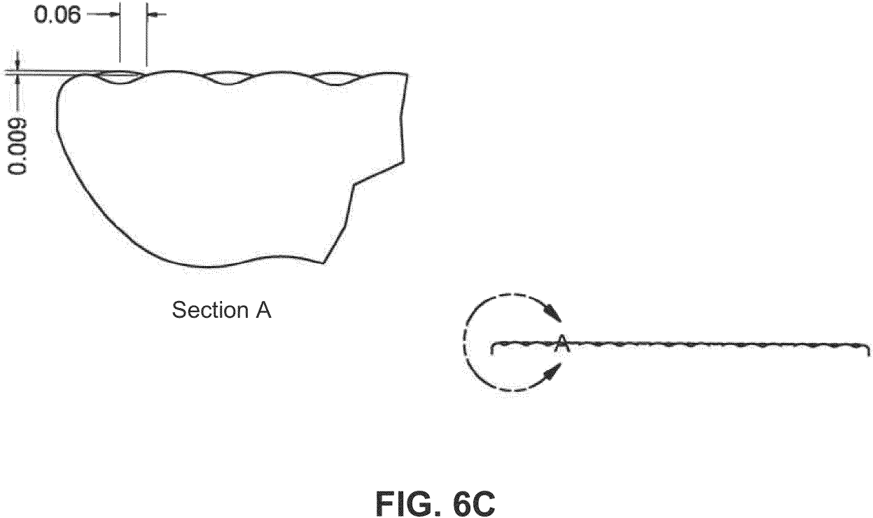

FIG. 1B presents an isometric view of an assembly 100 in an aspect of the innovation. It is to be appreciated that FIG. 1B portrays an embodiment similar to the replaceable implements as will be discussed in relation to FIGS. 6A through 8D herein. In an embodiment pictured of a context of a drumless material removal system, abrasive elements have been permanently attached to respective blades that comprise the drumless material removal system. It is to be appreciated that in this embodiment, another aspect of the innovation, alignment control (as will be discussed herein) may be provided not only for a radial plane of a single blade (which has successive abrasive elements 104N and 104N+1), but that alignment control may also act from one blade to the next across the span of the material removal system’s main axis (for example, along 106 as shown in FIG. 1A).

In an embodiment as shown in FIG. 1B, abrasive portions attached to shoulders are shown as centered along a thickness dimension of a blade element. While not shown, this centeredness is merely indicative of one set of embodiments, and other embodiments may provide the abrasive portion offset from a blade centerline in either direction from the centerline of the thickness dimension. In other words, abrasive sections, while pictured symmetrical to the blade element body, may be provided in an unsymmetrical manner (not shown), shifted either left, right, or a combination thereof of a blade element centerline. For example, in an embodiment, abrasive segments may be shifted beyond a side edge of the blade cores to produce a side clearance. In other embodiments, the disclosed innovation may be configured with abrasive sections of differently shifted blade elements, and even abrasive sections of an individual blade element may have differently shifted sections along the periphery of the blade element. Aspects of the present innovation may provide orientation control to facilitate these embodiments, as discussed herein.

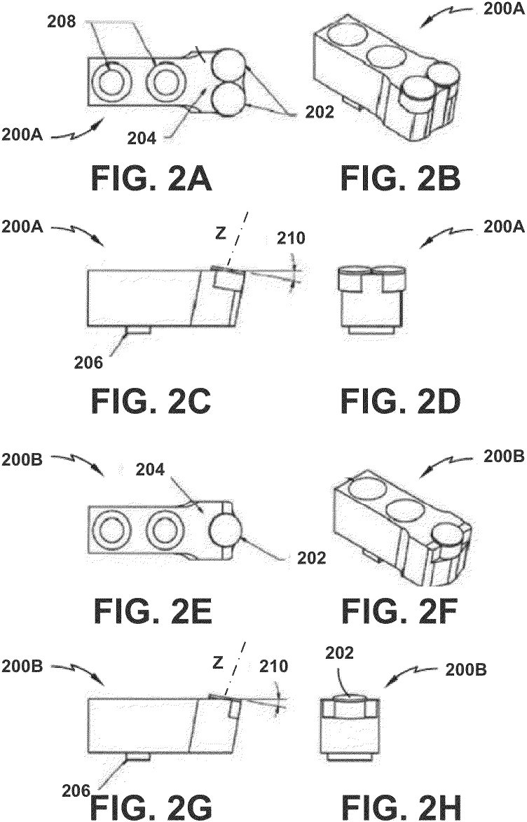

Turning now to FIGS. 2A-2H, pictured are views of a plurality of abrasive elements 202 in the form of a stock round, for which orientation control need not be provided. It is to be appreciated that in these examples, a plurality of stock rounds may be affixed permanently to holder 204, and the combination holder 204 and plurality of rounds 202 may serve as a replaceable abrasive implement. As shown in this embodiment, two versions shown, 200A, and 200B comprise a set, which may be used as a set such as 104S as disclosed herein.

An abrasive implement may be shown to comprise a holder portion 204 and a plurality of abrasive portions 202. Holder portion 204 may also be fashioned to receive a plurality of permanently mounted abrasives 202. A holder portion 204 may have a tongue (or key) 206 that may fit a corresponding groove in a shoulder portion of a mating blade element (not shown). Holder portion may also have attachment mechanisms 208, for example, holes for screws, bolts, and the like (not shown). The permanently amounted abrasive 202 may be of various shapes, such as round, rectangular, etc. (as shown in various figures and discussed herein), and compositions, such as polycrystalline diamond (PCD), and the attachment of the abrasive may be according to most any number of methods known in the art. Notwithstanding that a person having ordinary skill in the art may know how to attach an abrasive 202 to a holder 204, the disclosed innovation includes aspects that have been found to provide advantages over known methods in the art. For example, abrasive 202 may be attached at a swept back angle 210 from a top plane. It is appreciated that this angle 210 may be chosen based at least upon a designated end use of various designs or predetermined application related to a variety of surface materials to be worked and removed. For a non-limiting example, angle 210 may be in the range of 0-45 degrees, or more particularly in the range of 10-30 degrees, relative to the horizontal plane. It is to be appreciated that angle 210 may create an axis Z of rotation for plurality of rounds 202. It is also to be appreciated that in this configuration as shown, plurality of rounds 202 need not be controlled for orientation in respect to rotation around axis Z (in contrast to other embodiments highlighting aspects of the innovation featuring orientation control, as will be discussed later. Further examples include having abrasive 202 be chamfered at each corner of the leading edge, as well as from the inclined plane edge towards the three vertical edges. It is to be appreciated that chamfering and other designs of abrasive 202 are to be considered to be within the scope of the innovation.

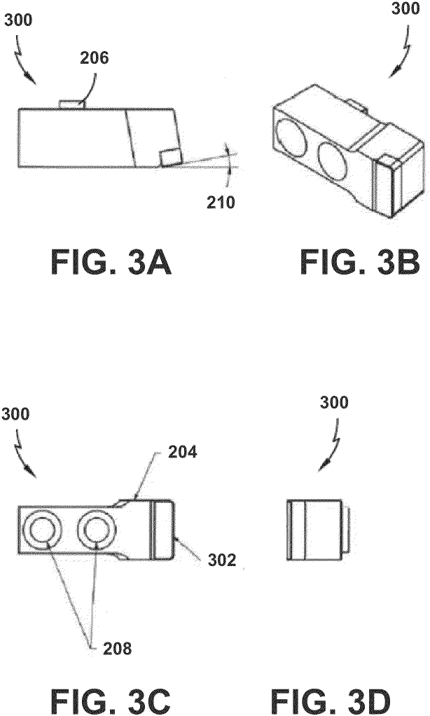

Turning to FIGS. 3A-3D, another example of an abrasive element 302 not needing orientation control is provided. In this example, abrasive element 302 portrays a bar shape that has no axis Z of rotation, as compared to the discussion in relation to FIGS. 2A-2H.

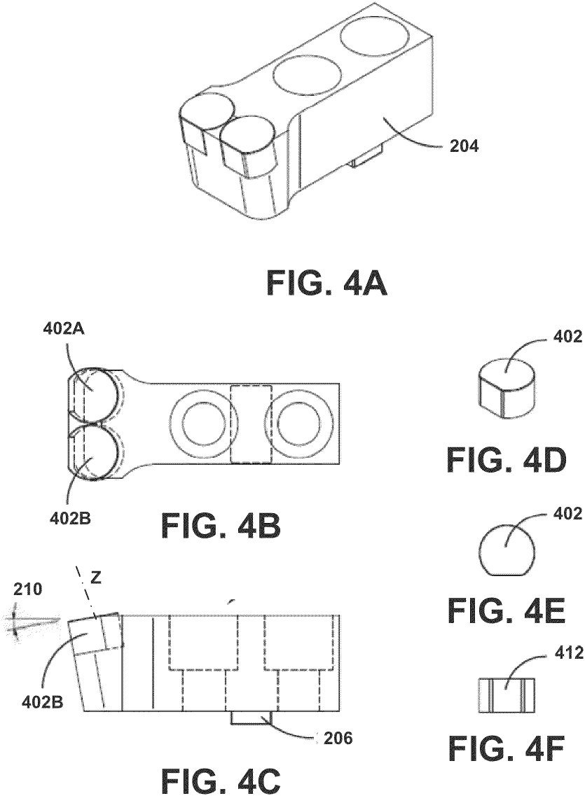

Turning now to FIGS. 4A-4F, an example combination of a plurality of abrasive elements 402 and holder 204 is portrayed. It is to be appreciated that in this embodiment, an abrasive round has been altered to provide a truncated round, with a face 412 at an interface to material to be worked in a material removal zone. In this example, it is to be appreciated that orientation control, contrasted as not shown in FIGS. 4A-4F, may provide an advantage over an assembly without orientation control. For example, placement and permanent attachment of the plurality of truncated rounds 402 into holder 204 may be difficult to control a rotation in any direction around the axis Z. Since the abrasive elements no longer are round in their entirety, rotations encountered while mounting the truncated rounds may cause a plurality of faces 412 to no longer align at a clear working edge (as such an alignment would be preserved with an aspect of the innovation as discussed herein). For example, truncated round 402A may rotate clockwise, while truncated round 402B may rotate counter clockwise, and a working edge then may present an angled line. This may be especially important in applications for which a first profile is followed by a second profile in a contained radial plane of action of an implement in a material removal system (for example, as shown in FIGS. 1A and 1B).

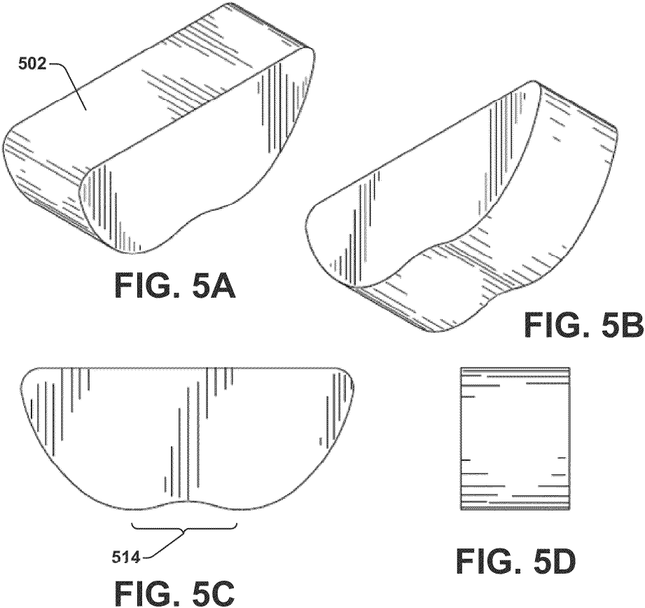

In an embodiment featuring a truncated round abrasive element, FIGS. 5A-5D present side, front and isometric views of an abrasive element similar to the element of FIGS. 4A-4F according to aspects of the innovation, but with a distinction of providing alignment feature 514. In these figures, the alignment feature 514 is shown that provides a saddle type of locator. It is to be appreciated that a holder (such as holder 204 for example), or a mating feature on a permanent placement (such as for example on a drum or plate, or on a blade in a drumless application) may provide a converse feature (not shown) to alignment feature 514. Alignment feature 514 then serves to prevent or reduce undesired rotation in assembly of either an abrasive implement or attaching an abrasive permanently to a material removal system component. As the alignment feature 514 provides a pre-determined settling point, rotation about a centerline through the approximate radius of the abrasive element is deterred, and alignment of the working edge is more easily preserved. It is to be appreciated that while the embodiment shown portrays alignment feature 514 as a continuous radial feature (as may provide for ease of manufacture and discussed herein), other configurations are considered to fall within the scope of the innovation. For example, a triangular or saw tooth feature (not shown), may provide for more controlled alignment or multiple configurable positions, as embodiments of such may be desired. It is to be appreciated that a triangular feature may provide for rounded tips and clearances in a mating feature so as to facilitate fabrication and assembly.

Turning to FIGS. 6A-6C, example sinusoidal profiles of a manufacture are presented. The periphery of a plurality of abrasive elements 104 (signifying 104S with both 104N and 104N+1) which occupy a working zone may be sinusoidal or near sinusoidal in shape. It has been discovered that it is preferable for certain embodiments to have a sinusoidal or near sinusoidal shape at this periphery as this provides a durable striking face (with minimal stress risers) while providing a highly controlled overlap from a first profile, such as 104N, to a second profile, such as 104N+1, acting in a rotary motion through the rotary plane, such as 102, as discussed earlier. It is to be appreciated that an embodiment in accordance with the present innovation may feature a set of periphery shapes that are non-sinusoidal, but that still create a destructive interference pattern when applied as disclosed (not shown).

It has been determined that an embodiment providing for destructive interference may be advantageous for providing material removal in situations designed to have a finer finish. As disclosed in the embodiment of FIGS. 6A-6C, an increase in overall effectiveness of material removal for certain materials, such as for example but not limited, flooring, asphalt or concrete may be provided as each crest removes a substantial portion of material being worked during a pass of a first profile of a manufacture (for example 104N) engaging with a surface being worked, while a following abrasive (for example 104N+1) serves to remove a weakened mid portion of the worked material of the surface being worked. It has been advantageously found that a sinusoidal shape provides an advantage of durability and strength of a near circular abrasive element, combined with a cutting/grinding footprint of a larger rectangular abrasive element. Such has shown benefits for example in concrete removal applications.

FIG. 6A provides views of abrasive elements according to an aspect of the innovation. A manufacture of an abrasive element with a sinusoidal periphery shape as in 104N as shown, as well as a manufacture of abrasive element with sinusoidal periphery shape as in 104N+1. It is to be appreciated that the two profiles are complimentary to each other, as each are of similar amplitude in their sinusoidal shape, but out of phase by 180 degrees (thereby providing destructive interference).

In embodiments, N may be equal to an integer and may represent the number of crests in a first profile. In the embodiment shown, N = 4. It is to be appreciated in this example; 104N+1 will then have five crests. Thickness 102 may be seen as extending slightly outboard past the crests of 104N+1. FIG. 6B provides a slightly angled view of the two elements 104N and 104N+1 as this view may better illustrate their effect in utilization as 104S. This view indicates the destructive interference of the sinusoidal pattern being out of phase by 180 degrees.

It is to be appreciated that destructive interference pattern approach may be controlled with choices of “N” and amplitude of the sinusoidal effect such that the surface of the material worked may have remaining ridge height and spacing controlled to most any desired ridge height and numbering. A specific example embodiment is shown in FIG. 6C, with “N” and amplitude choices that may provide a 0.06 crest to trough lateral dimension (across the working edge) while maintaining a ridge height of a 0.009 depth dimension.

While it is to be appreciated that the term "pairs' is used for ease of discussion, embodiments of paired abrasive elements need not be constrained strictly to an even number of abrasive elements in a rotary plane, but that a sinusoidal offset may be merely of one working abrasive element to a next in a particular rotary plane. In other words, the number of working abrasive elements in a rotary plane may be an odd number, rather than an even number, as long as at least two sequential working abrasive elements in a row are complimentary.

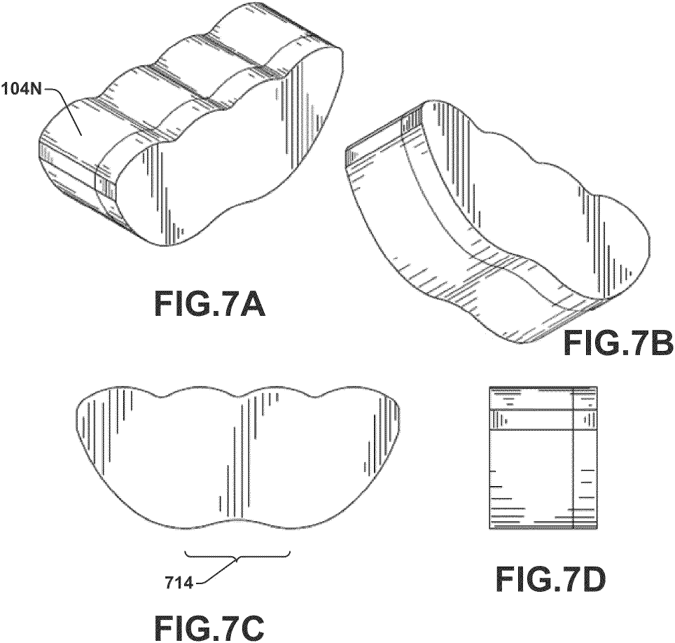

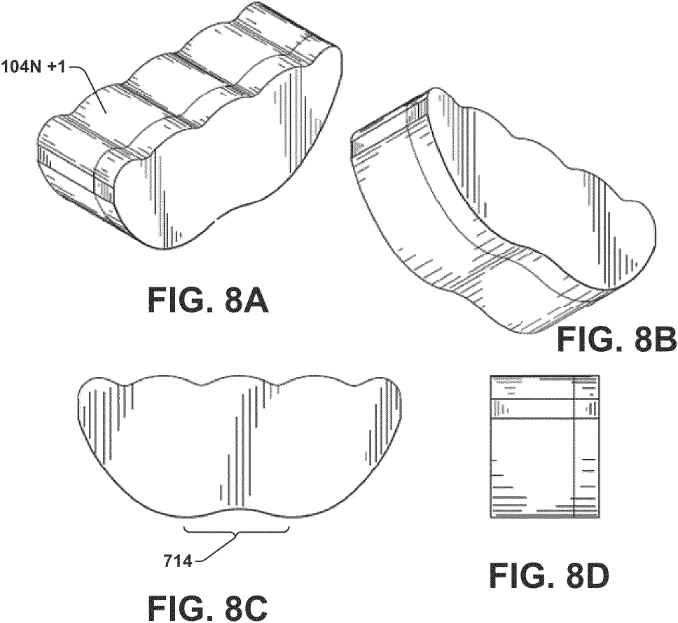

FIGS. 7A-7D and 8A-8D provide side, front and isometric views of an abrasive elements, such as 104N and 104N+1 according to aspects of the innovation. In these example embodiments, the working edge of abrasive elements 104N and 104N+1 is portrayed as a sinusoidal curve, with the sinusoidal curve of FIGS. 8A-8D being of similar amplitude as the sinusoidal curve of FIGS. 7A-7D, but out of phase by 180 degrees. Such a feature may provide additional advantages, such as for example, ease of manufacturing matched pairs of implements from a raw stock of a single round, as is discussed herein. It is to be appreciated that in this embodiment, alignment feature 714 provides alignment control and provides assurance of the destructive interference pattern of the sinusoidal working edges, as for example 104N and 104N+1.

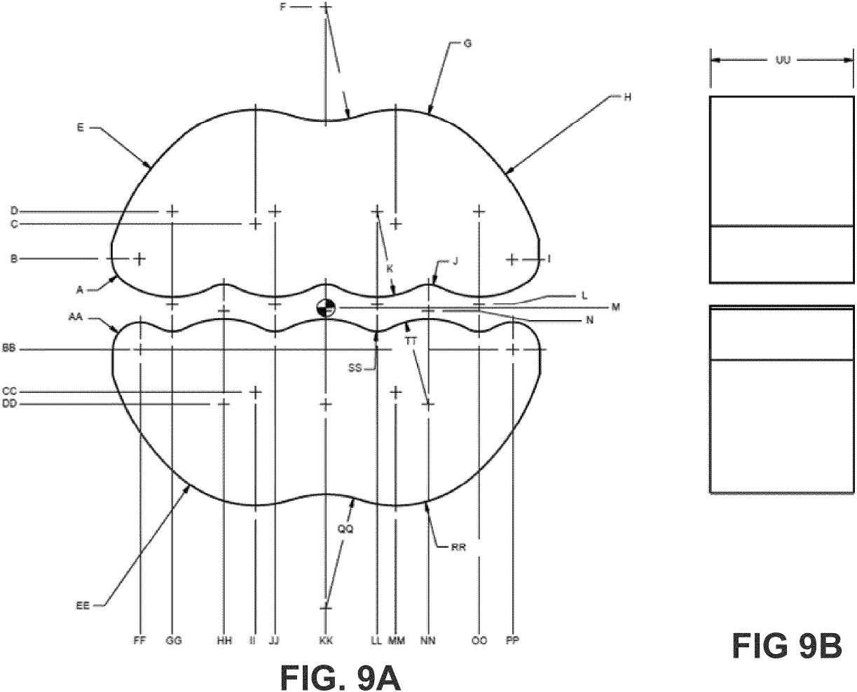

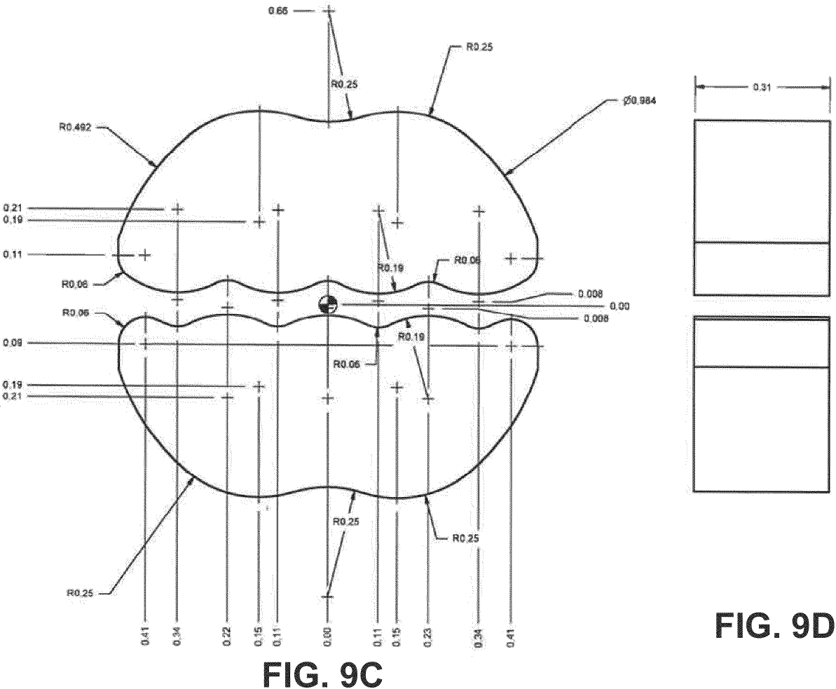

Turning now to FIGS. 9A-9D, an example front and side views of a manufacture of a pair of abrasive elements is provided. FIGS. 9A-9B provide an embodiment which may feature parametric sizing of dimensions to which a single round may be machined (machining as may be known in the art) with added efficiency and control of various aspects of the innovation, from saddle point locating feature of C, F, KK and QQ (for example), to the matching of sinusoidal crests and amplitudes of A and AA. It is to be appreciated that UU may be independent of other parametric related dimensions. It is to be further appreciated that some embodiments may provide aspects of the innovation that may be obtained without parametric dimensioning. FIGS. 9C-9D provide an embodiment with actual dimensions of a working piece. In these figures, pairing of complementary abrasive elements (for example, that may serve as sequential abrasive elements 104N and 104N+1 as discussed earlier) may be manufactured from a stock abrasive element according to aspects of the innovation. The example views show the pair being of similar sinusoidal design but out of phase by 180 degrees. It is to be appreciated that conventional abrasive elements may be supplied as starting with a single conventional blank in a round profile (as for example, radius R, or other examples such as E, H, G, EE or RR). Dimensions are provided in terms of letters that may be generated as desired in consideration of known fabricating techniques, but that in some embodiments may be parametrically associated with each other. Parametric association may, for example, provide efficiency in machining operations, as well as in reducing stress risers of a finished product. Parametric association may also provide for scalability across different starting points of stock round dimensions. It is to be appreciated that a number of crests for each of the sinusoidal selections may be selected based on a material to be worked (that is, may be selected for a particular end application), as different material applications may provide different desired levels of robustness of an abrasive element, and a lesser number of crests may provide deeper bite with durability trade-offs, while a greater number of crests may provide a finer finish with material removal rate trade-offs. In embodiments, different dimensions thus may be desired according to a number of different factors. In other embodiments (for example for those to which parametric sizing may be chosen), the dimensions may be desired to be related to each other. Thus, in embodiments, dimensions may be selected such that each dimension may be a predetermined amount that can be parametrically provided as a ratio of a starting dimension, such as for example the starting dimension of the radius of the conventional abrasive round element. In this manner, the manufacture of the paired abrasive elements may be signified by a parametric constant, and scalability may be achieved across different conventional starting blanks. As noted, FIGS. 9C-9D provide an example embodiment in which particular dimensions have been selected as an example choices for a particular application.

A method of manufacture may be demonstrated as follows. For a desired end application, a parametric constant may be determined. For the desired end application, a choice of a first number of crests of a selected sinusoidal pattern “N” and amplitude may be determined. A starting blank round may then be selected, and processing of the round in view of the selected attributes and parametric constant commenced, yielding a set, such as for example, 104S that provides destructive interference. It is to be appreciated that the processing may include parametric or non-parametric processing of an alignment feature. In other words, alignment features may be sized and selected parametrically or otherwise (for example, an alignment feature may be sized and selected based on a standard mounting size regardless of a chosen blank round diameter). It is further to be appreciated that for a desired end application, one or more of processing of a selected choice of “N”, amplitude, sinusoidal pattern, and alignment feature (or selected attributes) may be processed in a non-parametric fashion.

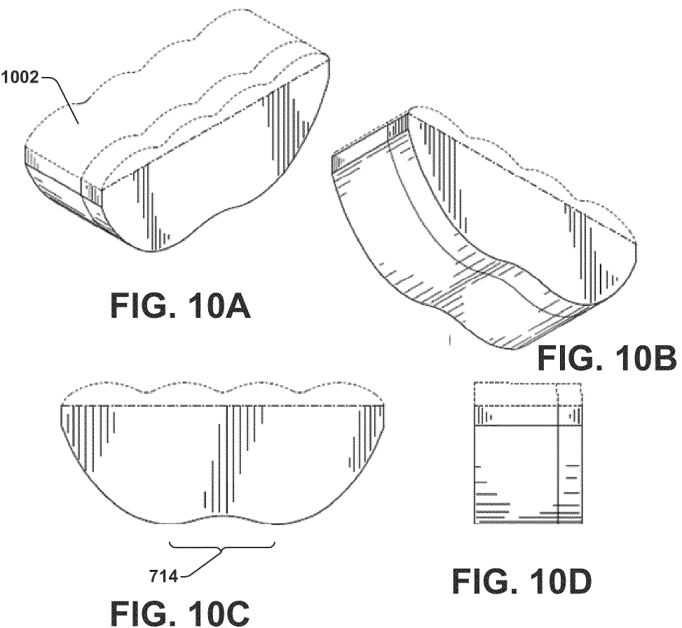

FIGS. 10A-10D provide side, front and isometric views of an abrasive element 1002 according to an embodiment that highlights a particular aspect of the innovation. In this example embodiment, the working edge is shown as a ghosted line. This example conveys the aspect of the innovation such that alignment feature 514 may be provided regardless of the profile of the abrasive element 1002 (or generally, most any abrasive surface) in the working zone. As discussed in relation to FIGS. 4A through 9D, the alignment feature may provide benefits regardless of many other options in the configuration of a working edge. It is to be appreciated that working strikeforce elements may be comprised - as disclosed herein in view of FIGS. 3A through 4D - that need not utilize the aspect of alignment feature 514 (or 714), but that the innovative aspect of having alignment feature 514 (or 714) may be obtained with or without parametric sizing of a sinusoidal effect, and may be presented with truncated rounds (as discussed in relation to FIGS. 5A-5D (there, 514).

While emphasis has been placed on the embodiments of the innovation illustrated and described herein, it will be appreciated that other embodiments, and equivalences thereof, can be made and that many changes can be made in the described embodiments without departing from the principles of the innovation. Furthermore, the embodiments described above can be combined to form yet other embodiments of the disclosed innovation. Accordingly, it is to be distinctly understood that the foregoing descriptive matter is to be interpreted merely as illustrative examples of the innovation and not as a limitation. It will be apparent to persons skilled in the art that a number of variations and modifications can be made without departing from the scope of the invention as defined in the claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of manufacturing a plurality of material removal elements for a material removal system, comprising:
splitting a subject round material removal element in order to create a matched pair of strikeforce implements with a first implement of the matched pair having a first profile shape and a second implement of the matched pair having a second profile shape;
wherein for the first profile shape and the second profile shape, for a respective portion of each profile shape, one of at least a sinusoidal pattern and a truncated round pattern is selected, and
wherein for the selection of a sinusoidal pattern:
selecting a first number of crests “N” for a first profile shape, which determines that the number of crests for a second profile shape is the first number plus one;
selecting an amplitude of the sinusoidal pattern;
wherein the respective portion of the second profile shape follows the respective portion of the first profile shape in a rotary path when the matched pair are mounted as a set to remove material in the material removal system and the matched pair creates a pattern of destructive interference upon being applied to a material being worked for a material removal application;
wherein for the selection of a truncated round pattern,
providing an alignment feature on each of the first implement and the second implement on a location outside of the respective portions of each profile shape of the respective first and second implements;
wherein the alignment feature prevents rotation of the first and second implement as each implement is attached to the material removal system relative to each other.

2. The method of claim 1, wherein for the selection of the sinusoidal pattern, dimensions of the first and second implements are based on a predetermined parametric constant.

3. The method of claim 1, wherein for the selection of the sinusoidal pattern, dimensions of the first and second implements are based on a predetermined semi-parametric constant.

4. The method of claim 1, wherein for the selection of the truncated round pattern, dimensions of the first and second implements are based on a predetermined parametric constant.

5. The method of claim 1, wherein for the selection of the truncated round pattern, dimensions of the first and second implements are based on a predetermined semi-parametric constant.

6. The method of claim 1, wherein the alignment feature comprises a saddle, triangle or sawtooth configuration.

7. A plurality of strikeforce implements fabricated to provide a matched set comprising:
a first strikeforce implement with a first profile in a working zone; and
a second strikeforce implement with a second profile in a working zone;
wherein the first profile and the second profile create a pattern of destructive interference upon being applied to a material being worked for a material removal application.

8. The plurality of strikeforce implements of claim 7, wherein each of the first strikeforce implement and the second strikeforce implement, each have an alignment feature on an area of the respective first and second implements that are not in a workzone of material being worked for the material removal application.

9. A plurality of strikeforce implements fabricated to provide a matched set comprising:
a first strikeforce implement with a first profile; and
a second strikeforce implement with a second profile;
wherein the first profile and the second strikeforce implements each have an alignment feature on an area of the respective first and second implements that are not in a workzone of material being worked for the material removal application.

10. The plurality of strikeforce implements of claim 9, wherein the first strikeforce implement has a first profile in a working zone, the second strikeforce implement has a second profile in a working zone, and wherein the first profile and the second profile create a pattern of destructive interference upon being applied to a material being worked for a material removal application.
